(19) United States
(12) Patent Application Publication
(10) Pub. No.: US 2016/0324318 A1
(43) Pub. Date: Nov. 10, 2016

(54) Guide Device for Guiding a Furniture Part Which Can be Moved Relative to a Furniture Body

(71) Applicant: Grass GmbH, Hochst (AT)

(72) Inventors: Peter LANGGUTH, Genthin (DE); Günter GRABHER, Fussach (AT)

(21) Appl. No.: 15/149,385

(22) Filed: May 9, 2016

(30) Foreign Application Priority Data
May 9, 2015 (DE) 202015003469.1

(51) Int. Cl. A47B 88/10; F16C 29/00; F16C 29/04; A47B 88/04

(52) U.S. Cl. CPC A47B 88/10; A47B 88/0422; F16C 29/005; F16C 29/04; A47B 2210/0013; A47B 2210/0048; A47B 2210/0037; A47B 2210/0059; A47B 2210/0075; F16C 2314/72

(57) ABSTRACT

In a guide device for guiding a furniture part, in particular a drawer, an extractable or the like, which can be moved relative to a furniture body, having at least one guide unit which comprises a body rail which can be fastened on the furniture body, a central rail mounted displaceable relative to the body rail by a lower rail guide, and an extraction rail mounted displaceable relative to the central rail by an upper rail guide and is connectable to an extractable, lower rail support for supporting the central rail on the body rail being provided in addition to the lower rail guide, and upper rail support for supporting the extraction rail on the central rail being provided in addition to the upper rail guide, the lower rail support and the upper rail support are actively connected to one another.

### CROSS REFERENCE TO RELATED APPLICATIONS

This application claims foreign priority under 35 U.S.C. §119(a)-(d) to Application No. DE 20 2015 003 469.1 filed on May 9, 2015, the entire contents of which are hereby incorporated by reference.

### FIELD OF THE INVENTION

The invention relates to a guide device for guiding a furniture part, in particular a drawer, an extractable or the like, which can be moved relative to a furniture body, having at least one guide unit which comprises a body rail which can be fastened on the furniture body, a central rail which is mounted displaceable relative to the body rail via a lower rail guide, and an extraction rail which is mounted displaceable relative to the central rail via an upper rail guide and can be connected to an extractable, lower rail support for supporting the central rail on the body rail being provided in addition to the lower rail guide, and upper rail support for supporting the extraction rail on the central rail being provided in addition to the upper rail guide.

### BACKGROUND

Such guide devices are known in a very wide variety of embodiments. A guide unit of a guide device, or a furniture extraction guide, which comprises a body rail, a central rail and an extraction rail, which are mounted displaceably relative to one another via rail guides, is also referred to as fully extractable. In the case of such fully extractables, distinction is made between a standard fully extractable and an overextractable. In the case of overextractables, the furniture part moved by the guide device can be extracted even further than in the case of a standard fully extractable, the extraction rail in the open position lying with its rear end at a distance in front of the front end of the body rail.

Under the effect of the force resulting from the applied bearing load, in guide systems with an overextraction length both the extraction rail and the central rail are lowered more greatly forward in the extraction direction than in guide systems without an overextraction length. Because of the lowering, the central rail may possibly lose its supporting role in relation to the extraction rail and the body rail, which can lead to collisions of the extraction rail with the body rail during insertion or extraction.

The lowering both of the extraction rail and of the central rail during extraction under a bearing load occurs not only in the case of overextractables but also in the case of standard extractables, although the problem is more pronounced in the case of overextractables.

### SUMMARY

The object of the invention is to provide a guide device which makes it possible to withstand higher weight and loading forces compared with conventional guide devices known from the prior art, the lowering behavior of the guide device being avoided.

In a guide device of the type mentioned in the introduction, this object is achieved according to the invention in that the lower rail support and the upper rail support are actively connected to one another. Refinements of the invention may be found in the dependent claims.

In this guide device according to the invention, the central rail rolls over the lower rail support relative to the body rail, and the extraction rail rolls over the upper rail support relative to the central rail. In order to ensure that the lower and upper rail support execute defined movements, that is to say that with different extraction positions of the individual rails they can themselves occupy defined positions with respect to one another, they are connected to one another in a positively controlled way. The effect of this positive control is that the lower rail support drives the upper rail support, and vice versa.

In one embodiment of the invention, the lower rail support and the upper rail support interact indirectly with one another. This may, for example, take place in that they interlock with one another or are connected to one another via a cable drive. In another variant, a spindle or a ball screw is used, by which the rail supports are connected to one another.

Preferably, the lower rail support comprises a rack/pinion combination consisting of at least one rack and at least one pinion which during insertion or extraction can be brought into interlocking engagement with, or is in interlocking engagement with, the rack. A rack/pinion combination offers the advantage that very high forces can be transmitted with it, and that they can transmit the forces without play. Furthermore, both racks and pinions are relatively simple and inexpensive to produce, and can be assembled without tools.

Particularly preferably, in the rack/pinion combination of the lower rail support, the pinion is arranged on the central rail and is mounted rotatably there, and the rack is arranged, formed or provided with upwardly directed teeth on the lower rail guide. If the upper longitudinal edge of the lower rail support is configured in a serrated fashion, i.e., provided with teeth, there is no need for an additional rack, and therefore a rack does not need to be fastened on the lower rail support, and its weight can be avoided.

Preferably, the upper rail support comprises a rack/pinion combination consisting of at least one rack and at least one pinion which during insertion or extraction can be brought into interlocking engagement with, or is in interlocking engagement with, the rack. Here again, rack/pinion combination offers the advantage that very high forces can be transmitted with it, and that it can transmit the forces without play.

Particularly preferably, in the rack/pinion combination of the lower rail support, here again the pinion is arranged on the central rail and is mounted rotatably there, and the rack is arranged, formed or provided with downwardly directed teeth on the upper rail guide. If the lower longitudinal edge of the lower rail support is configured in a serrated fashion, i.e., provided with teeth, here again there is no need for an additional rack, and therefore a rack does not need to be fastened on the lower rail support, and its weight can be avoided.

In one refinement of the invention, the pinion of the rack/pinion combination of the lower rail support and the pinion of the rack/pinion combination of the upper rail support are actively connected to one another. There is thus direct force and displacement transmission from one pinion to the other. Furthermore, full synchronization can thereby be achieved.

According to one preferred embodiment of the invention, the two pinions preferably are arranged offset in height relative to one another. This ensures that one pinion reliably interlocks only with one rack and the other pinion only interlocks with the other rack. In this case, the two pinions are driven by the racks and interlock directly or indirectly with one another.

In order to be able to transmit the forces from one rack to the other rack, according to one preferred embodiment at least one further or an odd number of transmission pinions is/are interconnected between the two pinions. The one or more transmission pinions have the advantage that they can be produced inexpensively, that they may consist of metal or plastic, that they are maintenance-free, and that they can be mounted simply on an axle neck which is rotatably mounted on the central rail. Advantageously, the two pinions are arranged running in the same direction as one another, or are driven in the same direction as to one another by the one or more transmission pinions.

Particularly preferably, the at least one transmission pinion or the plurality of transmission pinions are out of engagement with the racks. The transmission pinions are thus used merely to transmit the forces and moments from one pinion driven by the rack to the other pinion, which then drives its associated rack.

In one particularly preferred embodiment of the invention, the two pinions are configured in a synchronizing fashion. Both the forces and the moments of the one rack are transmitted fully synchronously to the other rack.

According to an alternative embodiment of the invention, the two pinions are connected to one another by a chain or a toothed belt, the pinions being configured as V-belt pulleys. Preferably, the toothed belt is configured as an externally toothed flat belt and is pressed via a deflection roller onto the pinion. A clamping roller for the belt may furthermore advantageously be provided.

In order to be able to configure the rails with different lengths, according to one preferred exemplary embodiment the two pinions are connected to one another via step-down or step-up gearing. In this way, the body rail may, for example, be made shorter than the extraction rail. Advantageously, the pinions themselves may also have a different number of teeth.

The invention furthermore comprises an item of furniture having a furniture part which can be moved relative to a furniture body and is guided by a guide device, which is distinguished by a guide device according to one of the claims.

### BRIEF DESCRIPTION OF THE DRAWINGS

Preferred exemplary embodiments of the invention are represented in the drawing and will be explained in more detail below. In the drawing:

FIG. 1 shows a side view of a guide unit of a first exemplary embodiment of the guide device, the extraction rail being in the extracted position;

FIG. 2 shows an enlarged side view of the guide unit according to FIG. 1, the extraction rail being in the inserted position;

FIG. 3 shows the detail III of the guide unit according to FIG. 2;

FIG. 4 shows the detail IV of the guide unit according to FIG. 1;

FIG. 5 shows a side view of a guide unit of a second exemplary embodiment of the guide device, the extraction rail being in the extracted position;

FIG. 6 shows an enlarged side view of the guide unit according to FIG. 5, the extraction rail being in the inserted position;

FIG. 7 shows the detail VII of the guide unit according to FIG. 6; and

FIG. 8 shows the detail VIII of the guide unit according to FIG. 5.

### DETAILED DESCRIPTION

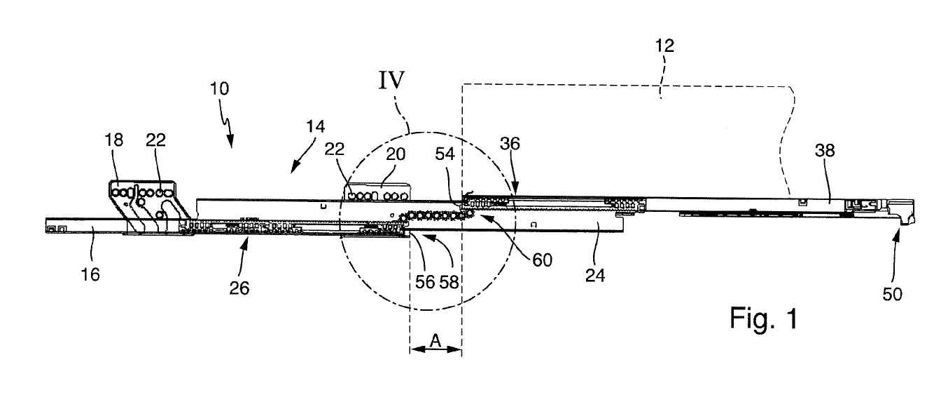

FIGS. 1 to 4 show a first exemplary embodiment of the guide device 10 according to the invention, which is shown by way of example when used on a furniture part 12 configured as a drawer. It is, of course, also possible to use the guide device 10 on other furniture parts, for example extractables such as extractable trays, extractable cabinets or the like.

In what follows, however, the guide device 10 according to the invention will be explained with reference to the exemplary case of a drawer. The drawer is mounted displaceably relative to a furniture body (not represented) by the guide device 10. The guide device 10 comprises at least one guide unit 14, in particular two guide units 14, which engage on opposite side surfaces of the drawer. Only a single guide unit 14 is shown the drawing, although the other guide unit arranged on the opposite side surface of the drawer is constructed in a corresponding way.

The guide units 14 respectively have a body rail 16, which is configured for example as a chamfered sheet-metal part. For fastening, the body rail 16 comprises a body bracket 18, which has at least one mounting cheek 20 that comprises a plurality of fastening openings 22 arranged successively, for example in rows, by which the body bracket 18 can be fastened securely in position with the aid of suitable fasteners on an assigned side wall of a drawer compartment formed in the furniture body. The body bracket 18 has a bearing section, which protrudes at an angle from the mounting cheek 20 and on which a central rail 24 likewise belonging to the guide unit 14 is guided displaceably in a manner to be explained below.

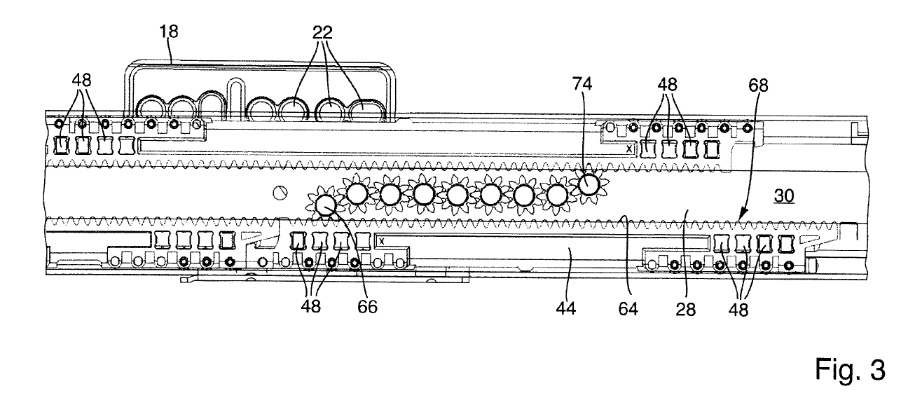

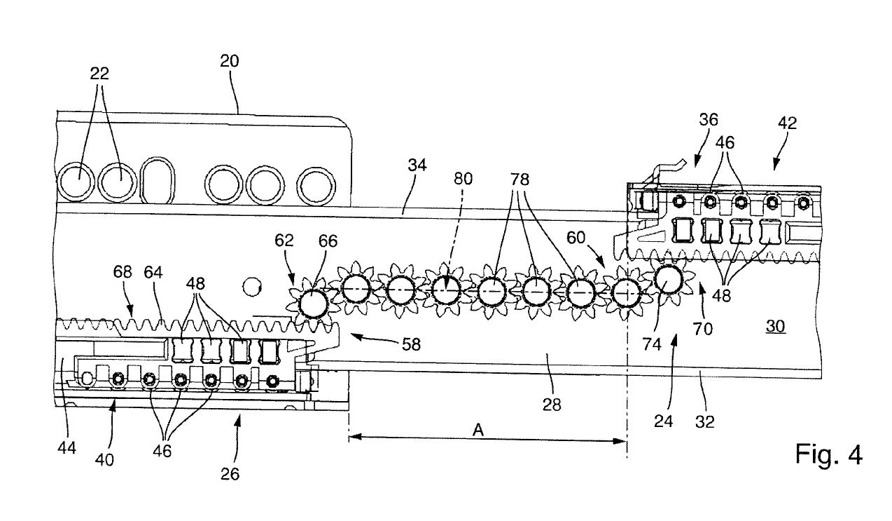

As represented particularly in FIGS. 3 and 4, the central rail 24 is mounted displaceably relative to the body rail 16 by the lower rail guide 26. Expediently, the central rail 24 is likewise configured as a profiled sheet-metal section, particularly with a U-shaped cross section. To this end, the central rail 24 has a base section 28, which is oriented vertically in the mounted state of the guide device 10, and which comprises a flat front side 30 and a flat rear side (facing away from the observer) facing toward the mounting cheek 20 of the body bracket 18. Two cheek sections 32, 34 extending essentially parallel to one another, each of which extends in the region of the rear side of the base section 28, are formed on the base section 28.

The upper and lower sides of the cheek sections 32, 34 form running surfaces for the lower rail guide 26 as well as for upper rail guide 36, the central rail 24 being mounted via the latter linearly displaceably on an extraction rail 38.

As represented particularly in FIG. 4, the lower and upper rail guide 26, 36 respectively have at least one roller carriage 40, 42. In the exemplary case, the lower rail guide 26 is assigned a lower roller carriage 40 and the upper rail guide 36 is assigned an upper roller carriage 42.

The lower roller carriage 40 has a carriage housing 44, which is assigned to the lower cheek section 32. The carriage housing 44 expediently consists of plastic material. The carriage housing 44 extends along the lower cheek section 32. In the carriage housing 44, a plurality of running rollers 46 are contained and mounted rotatably there via suitable bearings. The running rollers 46 are expediently grouped in a plurality of running roller groups, each of a plurality of running rollers 46. The rotation axes of the running rollers 46 extend in the plane of the assigned lower cheek section 32. Each running roller group has a multiplicity of upper running rollers 46 and a multiplicity of lower running rollers 46. The upper running rollers 46 of a running roller group are arranged successively in the longitudinal direction, their rotation axes being oriented parallel to one another. The upper running rollers 46 of a running roller group run with their running surfaces on the upper side of the assigned lower cheek section 32. The lower running rollers 46 of a running roller group lie opposite the upper running rollers 46 of the same running roller group, and one upper running roller 46 and one lower running roller 46 always lie pairwise opposite one another, the assigned cheek section 32 being received between the upper and lower running rollers. The lower running rollers 46 of a running roller group run with their running surfaces on the lower side of the assigned lower cheek section 32 of the central rail 24.

As shown particularly in FIG. 4, a plurality of running roller groups arranged successively in the rail longitudinal direction, each of which comprises upper and lower running rollers 46, are formed on the lower roller carriage 40. The arrangement of the upper and lower running rollers 46 of the other running roller groups is in the same way as for the running roller group described above.

FIG. 3 shows in particular the upper roller carriage 42, by which the extraction rail 38 is mounted linearly displaceable with respect to the central rail 24. The upper roller carriage 42 is assigned to the upper cheek section 34 of the central rail 24. A plurality of running roller groups, respectively of a plurality of upper and lower running rollers 46, are likewise formed. The upper running rollers 46 of the upper roller carriage 42 run on the upper side of the upper cheek section 34. The lower running rollers 46 of the upper roller carriage 42, on the other hand, run on the lower side of the upper cheek section 34. The upper cheek section 34 is thus in turn received between the upper and lower running rollers 46 of the running roller group.

The lower and upper roller carriages 40, 42 can be moved independently of one another.

As already mentioned, the lower running rollers 46 of a respective running roller group of the lower roller carriage 40 run on the lower side of the lower cheek section 32. Furthermore, these lower running rollers 46 run on an assigned running surface of the body rail 16. The lower roller carriage 40 is mounted displaceable both relative to the body rail 16 and relative to the central rail 24.

As already mentioned, the upper running rollers 46 of a respective running roller group of the upper roller carriage 40 run on the upper side of the upper cheek section 34. At the same time, they run on an assigned running surface of the extraction rail 38.

As represented particularly in FIGS. 3 and 4, both the upper and the lower roller carriages 40, 42 have support rollers 48, which are mounted rotatably in the respective carriage housings 44 and the rotation axes of which are oriented perpendicularly to the rotation axes of the running rollers 46, i.e., they lie in the plane of the base section 28 of the central rail 24. The support rollers 48 on the upper roller carriage 42 run on an assigned running surface on the extraction rail 38 and ensure lateral stabilization of the upper roller carriage 42. The support rollers 48 on the lower roller carriage 40 are assigned to a corresponding running surface of the body rail 16 and run thereon, and therefore ensure lateral stabilization of the lower roller carriage 40.

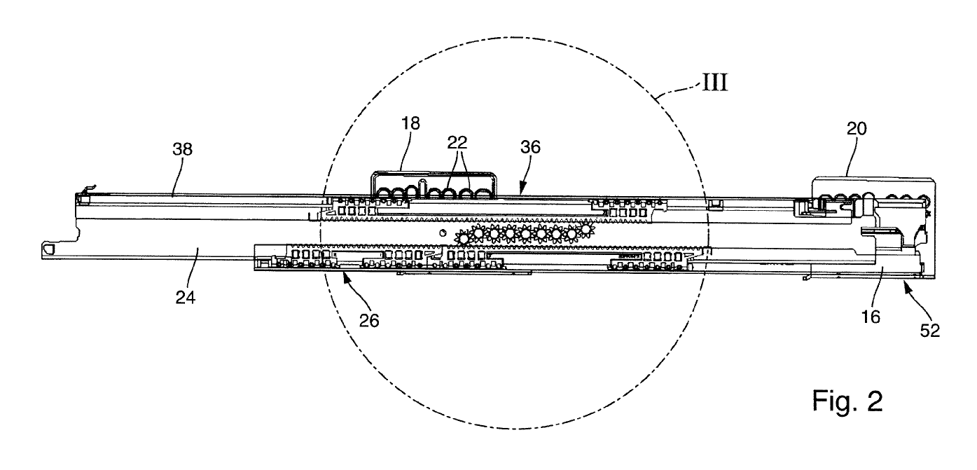

As represented particularly in FIG. 1, the extraction rail 38 is guided linearly displaceably with respect to the central rail 24 via the upper rail guide 36. The extraction rail 38 can move between an extracted position 50, which is represented in FIG. 1, and an inserted position 52 shown in FIG. 2.

The extraction rail 38, which in the exemplary case could also be referred to as a drawer rail, is coupled to the drawer via a coupler, in particular via a latch.

In the exemplary embodiments described, the guide unit 14 is configured as an overextractable. In this case, as represented particularly in FIG. 1, in the extracted position 50 and end 54 of the extraction rail 38, which is the rear end in the extraction direction of the extraction rail 38, is positioned at a distance A in front of the front end 56 of the body rail 16.

In order to prevent lowering of the extraction rail 38 and of the central rail 24, which is detrimental to the guiding behavior of the guide unit 14, particularly in the case of heavy loading of the drawer, and above all for such overextractables, rail supports 58, 60 are provided.

A support 58 is provided for supporting the central rail 24 on the body rail 16. In addition to the lower rail support 58, an upper rail support 60 is also provided for supporting the extraction rail 38 on the central rail 24.

In this case, the lower rail support 58 cooperates with the lower rail guide 26, and the upper rail support 60 cooperates with the upper rail guide 36.

As represented particularly in FIG. 4, the lower rail support 58 comprises a rack/pinion combination 62, which in the exemplary case comprise a rack 64 and at least one pinion 66, which during insertion or extraction can be brought into interlocking engagement with, or is in interlocking engagement with, the rack 64.

According to the first exemplary embodiment of the guide device according to the invention, which is shown in FIGS. 1 to 4, the pinion 66 lies on the front side 30 of the base section 28 of the central rail 24 and is mounted rotatably there via suitable bearings. As represented particularly in FIG. 3, the rack 64 assigned to the pinion 66 is arranged with upwardly directed teeth 68 on the lower rail guide 26. Expediently, the rack 64 lies on the carriage housing 44 of the lower roller carriage 40. The rack 64 may for example be connected as a separate component to the carriage housing 44, or, as shown in the exemplary case, it may be jointly formed during production of the carriage housing 44, which consists in particular of plastic material.

The upper rail support 60 likewise comprises a rack/pinion combination 70. Here again, a rack 72 and an assigned pinion 74 are provided. In a corresponding way to the rack/pinion combination 62 of the lower rail support 58, in the case of the upper rail support 60 the pinion 74 is likewise arranged on the front side of the base section 28 of the central rail 24, and is rotatably mounted there via suitable bearings. The assigned rack 72 is arranged on the upper rail guide 36, specifically on the carriage housing 44 of the upper roller carriage 42, as shown particularly in FIG. 3. The rack 72 has downwardly facing teeth 76. The pinion 74 is mounted rotatably via suitable bearings on the base section 28 of the central rail 24, and engages in the downwardly directed teeth 76 of the assigned rack 72 formed on the carriage housing 28.

In FIGS. 3 and 4, it can be seen that the two racks 64 and 72 are arranged offset in height relative to one another, and that in addition to the two pinions 66 and 74 fastened rotatably on the central rail 24, even more, in the exemplary embodiment represented seven, i.e., an odd number of transmission pinions 78 are arranged, which are likewise fastened rotatably on the central rail 24. The transmission pinions 78 lie along a line 80, which has an equal distance from the pinion 66 as from the pinion 74. The transmission pinions 78 therefore touch neither the rack 64 nor the rack 72. Furthermore, the transmission pinions 78 lie between the two pinions 66 and 74 and interlock therewith. The two pinions 66 and 74 are therefore driven counter to one another.

Starting from the inserted position 52 of the extraction rail 38 as shown in FIG. 2, the extraction rail 38 is moved in the direction of the extracted position 50 during extraction or opening of the drawer. Besides the rolling of the various running rollers 46 on their assigned running surfaces, the rack 72 provided on the upper roller carriage 42 moves on the assigned pinion 74. At the same time, the pinion 66 likewise arranged on the central rail 24 interlocks with the assigned rack 64 arranged on the lower roller carriage 40 and having the upwardly directed teeth 68. The racks 64 and 72 thus execute movements counter to one another. Beyond a certain extraction distance, the extraction rail 38 leaves the region of the body rail 16, so that overextraction takes place. In the extracted position 50 shown in FIG. 1, however, the pinion 66 arranged on the central rail 24 remains in engagement with the assigned rack 64 on the lower roller carriage 40, so that the central rail 24 can be supported on the body rail 16 by the roller carriage 40. At the same time, the extraction rail 38 is also supported by the rack 76 and the assigned pinion 74 on the central rail 24. Since, as already mentioned, the central rail 24 is supported on the body rail 16, the extraction rail 38 is correspondingly also supported on the body rail 16 by the central rail 24. The lowering behavior can therefore be avoided during extraction of the extraction rail 38 and of the central rail 24. Because the guide device 10 comprises two identically constructed guide units 14, and the pinions 66 and 74 interlock with one another via transmission pinions 78, full synchronization during the guiding can be achieved by the identically constructed rack/pinion combinations 62, 70 on the two guide units 14.

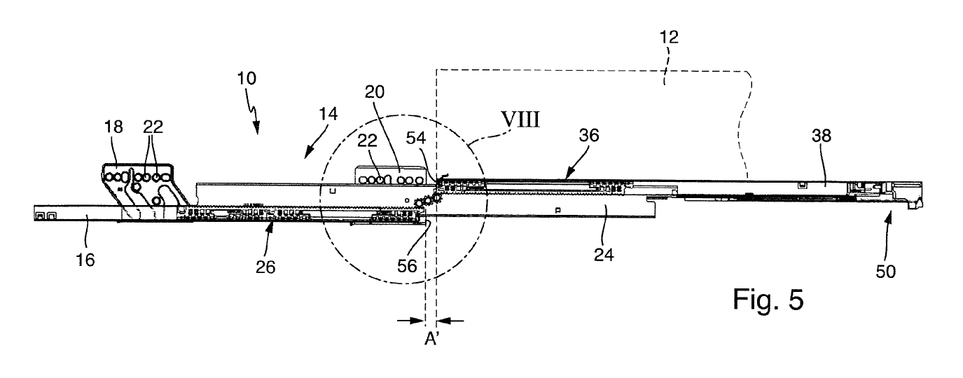

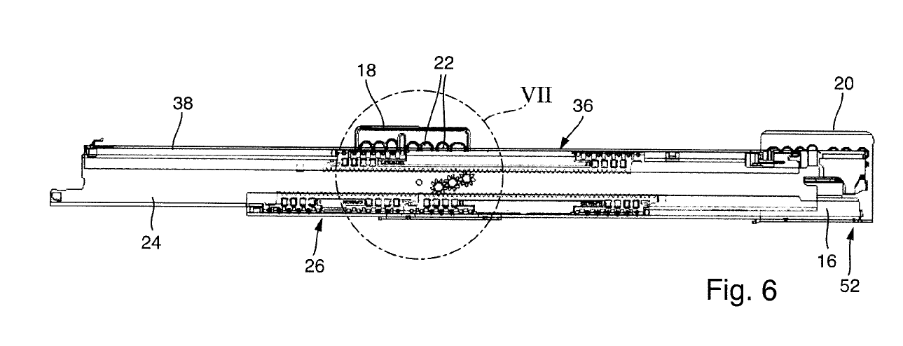

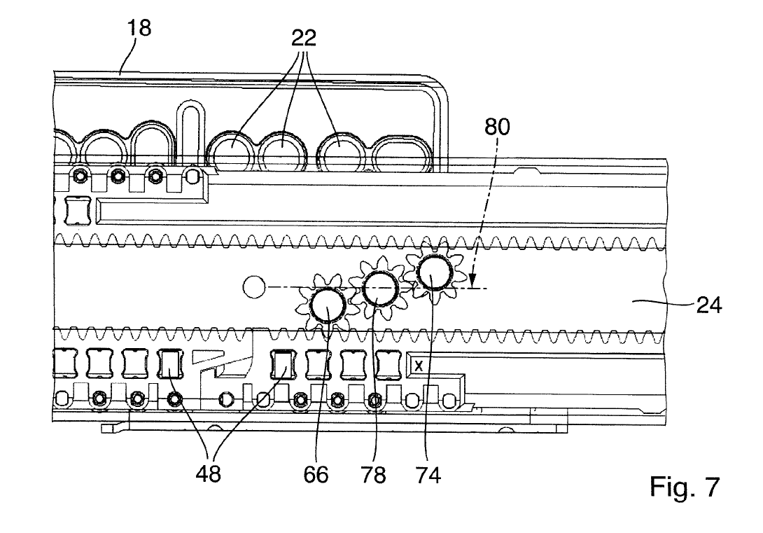

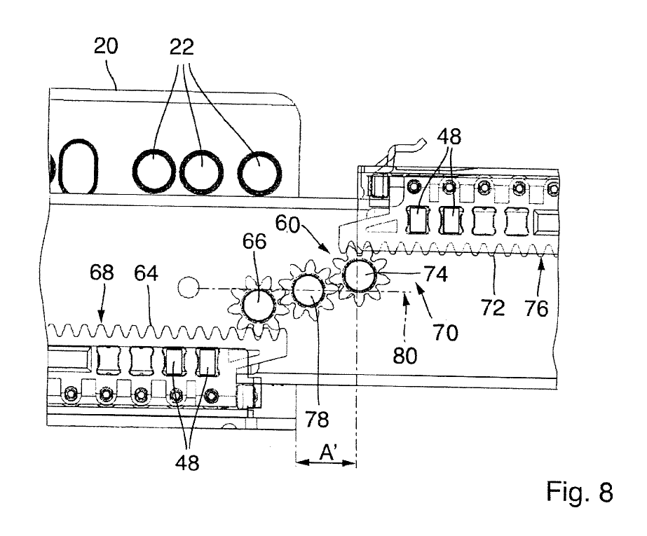

FIGS. 5 to 8 show a second exemplary embodiment of the invention, in which components that are the same have the same name and have the same reference. In this second exemplary embodiment, the guide device 10 comprises a body rail 16, a central rail 24 and an extraction rail 38, with which a furniture part 12 can likewise be extracted from a body, the guide unit 14 likewise being configured as an overextractable. In this case, as represented in FIG. 5, in the extracted position 50 and end 54 of the extraction rail 38, which is the rear end in the extraction direction of the extraction rail 38, is positioned at a distance A′ in front of a front end 56 of the body rail 16. This distance A′ is less than the distance A of the exemplary embodiment shown in FIGS. 1 to 4. This shorter distance A′ is due to the fact that only a single transmission pinion 78 is provided between the pinions 66 and 74, this one transmission pinion 78 likewise being arranged on the central rail 24 along the line 80 between the two pinions 66 and 74 and engaging therewith. By adjusting the number of transmission pinions 78, an odd number always being used, the distance A and therefore the extent of the overextraction can always be determined.

It is therefore possible to achieve a defined overextraction with fully synchronized guide units 14, even heavy furniture parts 12 being supported, and large weight and loading forces being withstood, in such a way that the extraction rail 38 is not lowered.

What is claimed is:

1. A guide device for guiding an extractable furniture part that is moveable relative to a furniture body, comprising:
at least one guide unit comprising:
a body rail configured to be fastened on the furniture body;
an upper rail guide and a lower rail guide;
a central rail mounted displaceably relative to the body rail via the lower rail guide;
an extractable, lower rail support configured to support the central rail on the body rail;
an extraction rail mounted displaceably relative to the central rail via the upper rail guide, the extraction rail being connectable to the lower rail support; and
an upper rail support configured to support the extraction rail on the central rail, wherein the lower rail support and the upper rail support are actively connected to one another.

2. The guide device according to claim 1, wherein the lower rail support and the upper rail support interlock indirectly with one another.

3. The guide device according to claim 1, wherein the lower rail support comprises a lower rack/pinion combination comprising at least one lower rack and at least one lower pinion that, during insertion or extraction, can be brought into interlocking engagement with, or is in interlocking engagement with, the lower rack.

4. The guide device according to claim 3, wherein the lower pinion is mounted rotatably on the central rail, and the lower rack includes upwardly directed teeth on the lower rail guide.

5. The guide device according to claim 1, wherein the upper rail support comprises an upper rack/pinion combination comprising at least one upper rack and at least one upper pinion that, during insertion or extraction, can be brought into interlocking engagement with, or is in interlocking engagement with, the upper rack, the upper pinion being rotatably mounted on the central rail, and the upper rack being arranged with downwardly directed teeth on the upper rail guide.

6. The guide device according to claim 5, wherein the lower pinion and the upper pinion are actively connected to one another, the lower and upper pinions being arranged offset in height relative to one another.

7. The guide device according to claim 6, wherein the lower and upper pinions are driven and interlock directly or indirectly with one another, the lower and upper pinions being driven by the lower and upper racks.

8. The guide device according to claim 7, further comprising an odd number of further transmission pinions interconnected between the lower and upper pinions, wherein the odd number is at least one.

9. The guide device according to claim 8, wherein adjacent ones of the further transmission pinions are interlocking with one another and are arranged running counter to one another.

10. The guide device according to claim 8, wherein the further transmission pinions are not in direct engagement with the lower and upper racks.

11. The guide device according to claim 6, wherein the lower and upper pinions are arranged running in the same direction as one another.

12. The guide device according to claim 6, wherein the lower and upper pinions are configured in a synchronizing manner.

13. The guide device according to claim 6, wherein the lower and upper pinions are connected to one another via a chain or a toothed belt.

14. The guide device according to claim 5, wherein the lower and upper pinions are connected to one another via step-down or step-up gearing.

15. An item of furniture, comprising:
the guide device according to claim 1;
a furniture body; and
a furniture part moveable relative to the furniture body and guided by the guide device.
